(19) United States
(12) Patent Application Publication
(10) Pub. No.: US 2016/0158971 A1
(43) Pub. Date: Jun. 9, 2016

(54) METHOD FOR MOLDING A BODY IN A MOLD

(71) Applicant: TESA SE, Norderstedt (DE)

(72) Inventors: Stephan BERNT, Hamburg (DE); Patrick KEREP, Hamburg (DE)

(73) Assignee: TESA SE, Norderstedt, OT (DE)

(21) Appl. No.: 14/908,302

(22) PCT Filed: Jul. 21, 2014
(86) PCT No.: PCT/EP2014/065585

§ 371 Date: Jan. 28, 2016

(30) Foreign Application Priority Data
Aug. 1, 2013 (DE) 10 2013 215 146.2
Oct. 28, 2013 (DE) 10 2013 221 847.8

(51) Int. Cl. B29C 33/60; B29C 33/58; B29C 70/48; B29C 70/44

(52) U.S. Cl. CPC B29C 33/60; B29C 70/443; B29C 33/58; B29C 70/48; B29K 2027/18

(57) ABSTRACT

Method for molding a body in a mold, comprising the steps of applying an adhesive tape (1) to the inside of a mold (4), distributing on the adhesive tape (1) the material layers (5) that form the body, curing the material layers (5), removing the body from the mold (4), wherein the adhesive tape (1) has a carrier film (10), onto one side of which a self-adhesive mass is dispensed, and the carrier film (10) contains one or at least two fluoropolymers.

This is a 371 of PCT/EP2014/065585 filed 21 Jul. 2014, which claims foreign priority benefit under 35 U.S.C. 119 of German Patent Applications 10 2013 215 146.2 filed Aug. 1, 2013, and 10 2013 221 847.8 filed Oct. 28, 2013, the entire contents of which are incorporated herein by reference.

The present invention relates to a process for the molding of a body in a mold, where a body, in particular a half-blade of a rotor installed in a wind turbine, is molded from a plurality of curable layers of material.

### BACKGROUND OF THE INVENTION

Many components, some of which have complex geometric structures, are produced by introducing hardenable material, for example epoxy resins or polyester resins, into a mold, with subsequent hardening.

Examples of processes of this type are RTM (resin transfer molding) and VRTM (vacuum-assisted resin transfer molding). Resin transfer molding is a process for the production of moldings from thermosets and elastomers. In contrast to the compression molding process, the molding composition here is injected by means of a piston from a mostly heated upstream chamber by way of runners into the mold cavity, in which it hardens with exposure to heat and pressure. The molding composition used can comprise formaldehyde resins (phenolic resins or aminoplastics) or reactive resins (polyesters, for example PET, or epoxy resins) with small filler particles; they can also be elastomers.

At the start of a cycle, the upstream chamber contains a metered quantity of a preplastified molding composition. The mold is first closed. The molding composition is then injected into the mold and allowed to remain in the mold for a certain time. During this “residence time”, reaction or vulcanization of the molding composition takes place. This is dependent on various factors (type of resin, filler, processing pressure, and processing temperature). Once the residence time has concluded, the mold can be opened. The molding composition previously injected is now solid (hardened), and is now termed a molding. This can now be removed from the mold. The mold is then cleaned, and another cycle can start.

The quantity of the molding composition required for injection here is always greater than the volume of the final molding, in order that the mold is completely filled. This ensures that the molding is completely formed and that no air is injected. Before the next cycle starts, the excess molding composition retained in the upstream chamber, also known as residue, has to be removed and replaced by fresh molding composition.

In order to avoid air inclusions, the cavity (mold cavity) is mostly also evacuated.

When long fibers or semifinished fiber products (prewovens/preform) are processed, these are inserted in advance into the mold, and the molding composition is injected around same. Here again, it is advantageous that the cavity (mold cavity) is mostly also evacuated.

The “prewovens processes” can be classified according to the number and design of the resin gates. The term injection is used below for the introduction of the resin into the semifinished fiber product, irrespective of the manner in which the pressure gradient is generated.
Pin-gate injection: the resin is injected into the semifinished product only at one point. When a pin gate is used the flow front can include air; this leads to defects.
Multipoint injection: the mold can be filled with resin more rapidly by using a plurality of injection points. Inclusion of air can be prevented by well-designed positioning.
Linear injection: in the case of linear injection, injection takes place along a line at the edge of the mold, rather than at a single point. This can be advantageous for large components, because the required flow path is no more than the length of the shorter edge.
Duct injection: the resin is injected through a wide duct located above or beneath the semifinished fiber product.
Cascade injection: in order to minimize the pressure gradient, a plurality of injection points are provided in the direction of the flow front. However, this requires sequential opening and closing of the injection lines along the flow front.

Known types of mold are hard molds, soft molds, and mixed types.

Injection resins used are resins having low viscosity. Flow resistance therefore remains low when the material flows through the mold, and the filling process requires smaller pressure differences. Reactive resins marketed for RTM processes are specific injection resins composed of a resin component and hardener component. Low-reactivity resin systems can be mixed before infusion. If high-reactivity resin systems are to be used, mixing of resin and hardener has to be delayed until they have reached the fusion line or the mold. This allows achievement of lower cycle times. Processes where mixing of the injection resin components is delayed until immediately prior to injection are known as RIM processes (reaction injection molding).

Further details can be found in Römpp's chemical encyclopedia, and specifically under the keyword “Spritzgieβen” (2013 Georg Thieme Verlag, document number RD-19-03499, most recent update: July 2011).

The construction of a body, for example the (half-)blade of a rotor installed in a wind turbine, uses glassfiber mats which are introduced as sublayers into a suitably designed mold. The layers are then adhesive-bonded by a resin and cured in the mold to give a fiber-reinforced polymer or a glassfiber-reinforced plastic.

In order to ensure easy demolding that does not destroy the product, the mold providing the negative, and where appropriate also the positive, replication of the part to be constructed has to be prepared with an antiadhesive material, which is applied prior to the application of the layers to the mold.

Release agents such as polyvinyl alcohol or silicone waxes are often used here. There are also known release agents based on silane or on siloxane, for example the products from the Frekote line from Henkel. PTFE-coated glass textile is also used; this is applied in the form of an adhesive tape to the mold, and replaces the release agent.

The release agent is applied in a uniform layer, and this layer has to be absolutely smooth, in order that the exterior surface of the body is likewise smooth.

The liquid release agents usually used are solvent-based, and require a drying and hardening time that is always from 20 to 30 min. Application of the release agent likewise takes from 20 to 30 min.

Some users find it necessary to refresh the release agent prior to each construction cycle, the resultant total unproductive time being 1.5 h prior to each construction cycle.

Another disadvantage that should be mentioned is that the release agents transfer to some extent onto the component; direct subsequent further processing, for example by coating, thus becomes more difficult. The release agent has first to be removed; this is likewise time-consuming.

It is moreover known that the release action of these release agents is not fully satisfactory. Because the resin has direct contact with the mold, deposition of a small quantity of the resin takes place at some points after each demolding cycle. The cumulative effect of this is sufficiently great that after a number of cycles which may be 200, depending on the severity of the phenomenon, the mold has to be ground and polished, because otherwise the demolded components will no longer have the required dimensional accuracy.

Some of the release agents used are based on organic solvents which evaporate during drying and pollute the atmosphere. In certain cases additional safety precautions have to be taken in this connection in order to minimize the risk of fire or explosion.

A little-used alternative consists in lining the component mold with PTFE-coated fabric-backed adhesive tapes. These have longer replacement intervals, depending on their quality, and provide good release action. This especially saves time, which can be utilized for further production cycles.

The process of application of the fabric-backed adhesive tape in the three-dimensional mold is disadvantageous because care has to be taken to minimize the occurrence of irregularities, for example air bubbles, under the adhesive tape, and the occurrence of overlapping adhesive tape edges and creases.

The difficulty of achieving this is enormously increased by the stiffness and lack of flexibility of the PTFE-treated glass-textile backing.

Production of a PTFE-coated fabric usually involves covering the upper side and the underside of very wide material with PTFE and subsequently slitting up the same to give a large number of rolls of the desired width. No PTFE is therefore present at the slit edges of the rolls. This in turn has the consequence that the textile, and therefore the adhesive tape, absorbs liquid resin until it becomes saturated in the mold; this reduces the extent of release action and/or reduces the number of cycles before complete replacement of the tape is required.

The quality of PTFE-treated glass-textile backings varies greatly. It is almost impossible to prevent what is known as microcracking in the PTFE layer, allowing ingress of the resin. The frequency of occurrence of said cracking is quality-dependent. A consequence of this cracking is that the central portion of the adhesive tape absorbs resin until it becomes saturated; as described in the previous paragraph this leads to reduced lifetime.

It is moreover impossible (as is the case with any fabric) to prevent fraying of the glassfiber fabric at the slit edges and protrusion of individual fibers into the mold. A consequence of this when the component is demolded is that the fibers, and to some extent the adhesive tape, are concomitantly removed. Once this type of damage has been caused, the damaged area increases rapidly and a patch therefore has to be applied to the resultant gap. The resultant new edges are likewise susceptible to damage, and this process of deterioration is therefore self-perpetuating.

A PTFE-coated fabric-backed adhesive tape therefore also progressively loses its release action, and therefore has to be replaced after, for example, 30 demoldings.

### SUMMARY OF THE INVENTION

It is an object of the present invention to provide a process for the molding of a body made of hardenable layers of material in a mold, said process being optimized in relation to steps in the cycle thereof via an improved adhesive tape that is used between the mold and the layers of material.

Accordingly the invention provides a process for the molding of a body in a mold, comprising the following steps:
application of an adhesive tape on the internal side of a mold
distribution, on the adhesive tape, of the layers of material that form the body
hardening of the layers of material
removal of the body from the mold,
   where the adhesive tape comprises a backing foil onto one side of which an adhesive, in particular self-adhesive, has been spread, and the backing foil comprises one or at least two fluoropolymers.

In a preferred variant of the process, the internal side of the mold is equipped with a release agent prior to application of the adhesive tape.

It is further preferable that the hardening of the layers of material takes place in vacuo.

The individual steps of the process are explained at greater length by way of example in EP 2 388 131 A1.

### DETAILED DESCRIPTION OF THE INVENTION

The expression fluoropolymers or fluorine-containing polymers means for the purposes of this invention in general terms any fluorine-containing polymer with exclusively carbon atoms and also any such polymer with heteroatoms in the main chain. Homo- and copolymers of olefinically unsaturated fluorinated monomers are members of the first group.

The fluoropolymers resulting from said monomers are classified into the following categories: polytetrafluoroethylene, fluorothermoplastics, fluororubbers, and the fluoroelastomers obtained therefrom by vulcanization. The most important representatives of the fluoropolymers with heteroatoms in the main chain are the polyfluorosiloxanes and polyfluoroalkoxyphosphazenes.

The backing foil preferably comprises 50% by weight, more preferably 75% by weight, particularly preferably 90% by weight, and very particularly preferably 95% by weight, of one or at least two fluoropolymers (based in each case on the entire composition of the backing foil).

It is further preferable that the polymers forming the backing foil are composed of 100% by weight of one or at least two fluoropolymers. The additives described below can also optionally have been added to the fluoropolymers. Said additives are—as has been said—not essential; they can also be omitted.

Fluoropolymers that are in particular suitable are PTFE (polytetrafluoroethylene), ETFE (poly(ethylene-co-tetrafluoroethylene)), FEP (poly(tetrafluoroethylene-co-hexafluoropropylene)), PVDF (poly(1,1-difluoroethene)), and PFA (perfluoroalkoxy polymers), and mixtures of two or more of the fluoropolymers mentioned.

PTFE means fluoropolymers composed of tetrafluoroethene monomers.

ETFE is a fluorinated copolymer composed of the monomers chlorotrifluoroethylene or else tetrafluoroethylene and ethylene.

FEP, another term for which is fluorinated ethylene-propylene copolymer, means copolymers of tetrafluoroethene and hexafluoropropene.

PVF is a polymer produced from vinyl fluoride (polyvinyl fluoride).

PCTFE is a polymer composed of chlorotrifluoroethylene (polychlorotrifluoroethylene).

ECTFE is a copolymer composed of ethylene and chlorotrifluoroethylene.

PVDF means fluoropolymers that can be produced from 1,1-difluoroethene (vinylidene fluoride).

PFA means copolymers with groups such as

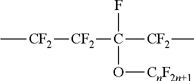

as fundamental units [poly(tetrafluoroethene-co-perfluorinated alkyl vinyl ether)]. PFAs result from copolymerization of tetrafluoroethene and perfluorinated alkoxy vinyl ethers (for example perfluorinated vinyl propyl ether, n=3).

The fluoropolymers can have been mixed with other polymers; good miscibility of the fluoropolymers with the other polymers is required here.

Suitable polymers are olefinic polymers, for example homo- or copolymers of olefins, for example ethylene, propylene, or butylene (where the meaning of the term copolymer here includes terpolymers), polypropylene homopolymers and polypropylene copolymers, inclusive of block (impact) polymers and random polymers.

Other polymers can be selected, alone or in a mixture, from the group of the polyesters, for example in particular polyethylene terephthalate (PET), polyamides, polyurethanes, polyoxymethylene, polyvinyl chloride (PVC), polyethylene naphthalate (PEN), ethylene-vinyl alcohol (EVOH), polyvinylidene chloride (PVDC), polyvinylidene fluoride (PVDF), polyacrylonitrile (PAN), polycarbonate (PC), polyamide (PA), polyether sulfone (PES), polyimide (PI), polyarylene sulfides, and/or polyarylene oxides.

The polymers used to form the backing foil can be present in unblended form or in blends with additives, for example antioxidants, light stabilizers, antiblocking agents, lubricants and processing aids, fillers, dyes, pigments, blowing agents, or nucleating agents.

It is preferable that the foil does not comprise any of the additives mentioned—with the exception of dyes. It is preferable to use dyes, but it is not essential that they are present.

In a preferred embodiment the backing foil is composed of an at least two-layer laminate made of two or more foil layers. It is preferable that the multilayer backing foil is composed of up to ten foil layers, in particular of from two to five foil layers.

The outermost foil layer, i.e. the layer facing toward the layers of material forming the body, is the backing foil comprising one or at least two fluoropolymers. Between this backing foil and the adhesive there can be other foil layers present made of any desired material (for example of polyethylene, polypropylene, polyester, PA, PVC, or other foils). The material of which the other foil layers are composed can also be the same as that of the outermost foil layer.

In one preferred embodiment of the invention the backing foil is composed of at least two foil layers, where the two exterior foil layers are of different color, the preferred number of foil layers being precisely two.

This method provides a simple wear-detection system that is nevertheless clearly discernible. Once the outermost foil layer has been removed by abrasion at some points as a result of wear, the foil layer located thereunder, which as mentioned is of a different color, becomes visible at these points. (The colorings should, of course, be selected in such a way as to produce appropriate contrast.) Visibility of the lower foil layer is therefore an indication that it is time to replace the adhesive tape.

In a preferred embodiment the thickness of the backing foil is from 15 to 350 μm, preferably from 30 to 200 μm, more preferably from 50 to 150 μm.

It is preferable that the adhesive applied on the backing foil is a pressure-sensitive adhesive, i.e. an adhesive which can give durable bonding to almost any adhesion substrate even when the pressure applied is relatively weak, and after use can in turn be peeled from the adhesion substrate to leave in essence no residue. A pressure-sensitive adhesive has permanently pressure-sensitive-adhesive properties at room temperature, i.e. has sufficiently low viscosity and high grab, and therefore covers the surface of the respective adhesion substrate even when the pressure applied is small. The adhesive bonding capability of the adhesive derives from its adhesive properties, and its peelability derives from its cohesive properties.

Any of the known adhesive systems can be used to produce an adhesive tape from the backing. Use may be made not only of natural- or synthetic-rubber-based adhesives but in particular also of silicone adhesives, and also of polyacrylate adhesives, preference being given to a low-molecular-weight pressure-sensitive hot-melt acrylate adhesive.

Preference is given to adhesives based on acrylate or on silicone.

The adhesive can in principle be selected from the group of the natural rubbers or the synthetic rubbers, or from any desired blend made from natural rubbers and/or from synthetic rubbers, where the natural rubber(s) can in principle be selected from any of the types obtainable, for example crepes, RSS, ADS, TSR, or CV types, in accordance with the required level of purity and viscosity, and the synthetic rubber(s) can be selected from the group of the randomly copolymerized styrene-butadiene rubbers (SBR), the butadiene rubbers (BR), the synthetic polyisoprenes (IR), the butyl rubbers (IIR), the halogenated butyl rubbers (XIIR), the acrylate rubbers (ACM), the ethylene-vinyl acetate copolymers (EVA), and the polyurethanes, and/or blends thereof.

In order to improve processability it is moreover preferable to add, to the rubbers, thermoplastic elastomers in a proportion by weight of from 10 to 50% by weight, specifically based on the total content of elastomer.

Representative types that may be mentioned at this point are especially the particularly compatible styrene-isoprene-styrene (SIS) and styrene-butadiene-styrene (SBS) types. Other suitable blending elastomers are, for example, EPDM rubber, EPM rubber, polyisobutylene, butyl rubber, ethylene-vinyl acetate, hydrogenated block copolymers of dienes (for example from hydrogenation of SBR, cSBR, BAN, NBR, SBS, SIS, or IR, polymers of this type being known, for example, as SEPS and SEBS), and acrylate copolymers, for example ACM.

A 100% system based on styrene-isoprene-styrene (SIS) has also proven to be suitable.

Crosslinking is advantageous for improving the peelability of the adhesive tape after use, and can take place thermally or via irradiation with UV light or electron beams.

For the purpose of thermally induced chemical crosslinking it is possible to use any of the known thermally activatable chemical crosslinking agents, for example accelerated sulfur systems or accelerated sulfur-donor systems, isocyanate systems, reactive melamine resins, formaldehyde resins, and (optionally halogenated) phenol-formaldehyde resins, or reactive phenolic-resin or diisocyanate crosslinking systems with the corresponding activators; it is also possible to use epoxidized polyester resins and epoxidized acrylate resins, and also combinations thereof.

The crosslinking agents are preferably activated at temperatures above 50° C., in particular at temperatures of from 100° C. to 160° C., very particularly at temperatures of from 110° C. to 140° C.

The thermal excitation of the crosslinking agents can also be achieved via IR radiation or alternating high-energy fields.

It is possible to use adhesives based on solvent, based on water, or else in the form of hot-melt system. A material based on acrylate hot-melt is also suitable, and this can have a K value of at least 20, in particular more than 30, obtainable via concentration of a solution of said material to give a system that can be processed as hot-melt.

The concentration process can take place in appropriately equipped tanks or extruders, and in particular if this is attended by devolatilization preference is given to a vented extruder.

An adhesive of this type is described in DE 43 13 008 A1, the content of which is hereby incorporated by way of reference, becoming part of this disclosure and invention.

Chemical crosslinking of the adhesive based on acrylate hot-melt is, however, also possible.

In another embodiment materials used as self-adhesives are copolymers of (meth)acrylic acid and esters thereof having from 1 to 25 carbon atoms, maleic, fumaric, and/or itaconic acid and/or esters thereof, substituted (meth)acrylamides, maleic anhydride, and other vinyl compounds, for example vinyl esters, in particular vinyl acetate, vinyl alcohols, and/or vinyl ethers.

Residual solvent content should be less than 1% by weight.

An adhesive found likewise to be suitable is a low-molecular-weight pressure-sensitive hot-melt acrylate adhesive marketed by BASF as acResin UV, or Acronal®, in particular Acronal® DS 3458 or AC Resin A 260UV. This adhesive with low K value obtains its appropriate usage properties via final crosslinking induced by ionizing radiation.

Mention may finally also be made of the suitability of polyurethane-based adhesive.

The self-adhesive used can have been blended with one or more additives in order to optimize properties, examples being tackifiers (resins), plasticizers, fillers, pigments, UV absorbers, light stabilizers, aging retarders, crosslinking agents, crosslinking promoters, and elastomers.

Tackifiers are by way of example hydrocarbon resins (for example derived from unsaturated C₅- or C₇-monomers), terpene-phenolic resins, terpene resins derived from feedstocks such as α- or β-pinene, aromatic resins such as coumarone-indene resins, or resins derived from styrene or α-methylstyrene, for example colophony and its downstream products, for example disproportionated, dimerized, or esterified resins, and it is possible here to use glycols, glycerol, or pentaerythritol. Particularly suitable materials are aging-resistant resins having no olefinic double bond, for example hydrogenated resins.

Express reference may be made to the description of the state of the art in “Handbook of Pressure Sensitive Adhesive Technology” by Donatas Satas (van Nostrand, 1989).

Examples of suitable fillers and pigments are carbon black, titanium dioxide, calcium carbonate, zinc carbonate, zinc oxide, silicates, and silica.

Examples of suitable plasticizers are aliphatic, cycloaliphatic, and aromatic mineral oils, di- or polyesters of phthalic acid, trimellitic acid, or adipic acid, liquid rubbers (for example nitrile rubbers or polyisoprene rubbers), liquid polymers derived from butene and/or isobutene, acrylic esters, polyvinyl ethers, liquid resins and plasticizer resins based on the feedstocks for tackifying resins, wool wax, and other waxes, and liquid silicones.

Examples of crosslinking agents are phenolic resins, halogenated phenolic resins, melamine resins, and formaldehyde resins. Examples of suitable crosslinking promoters are maleimides, allyl esters such as triallyl cyanurate, and polyfunctional esters of acrylic and methacrylic acid.

Anchoring is usually sufficiently strong to allow problem-free unwinding of this type of adhesive tape from a roll without disrupting the anchoring of the adhesive with resultant transfer of the adhesive (where the adhesive is then present on the reverse side of the backing). Most pressure-sensitive adhesive tapes are moreover expected to be amenable to peeling from the substrate, i.e. to removal leaving little or no trace. This means that no adhesive fracture between backing and adhesive is permitted.

In a preferred embodiment the quantity of the adhesive applied to the backing foil is from 10 to 200 g/m²; preferably from 20 to 100 g/m², particularly preferably from 30 to 75 g/m².

Layers of material used to form the molding are in particular fiber material (for example GRP (glassfiber-reinforced plastic), CRP (carbon-fiber-reinforced plastic), or prepreg, etc. Prepreg means a semifinished product which is especially used in lightweight construction, composed of continuous-filament fibers and of an uncured thermoset matrix. The continuous-filament fibers can take the form of simple unidirectional layer, or of fabric, or of laid scrim.

In order to increase the adhesion between the adhesive and the backing material or between release coating and backing material, the backing material can be subjected to a corona treatment to increase surface energy.

In order to improve the adhesion of the adhesive on the foil, and thus residue-free peelability after use, it is advantageous to use a primer layer between backing foil and adhesive.

Etching of the foil is moreover advantageous to permit anchoring of the adhesive.

Descriptions of the adhesives usually used for adhesive tapes, and also primers, are found, for example, in “Handbook of Pressure Sensitive Adhesive Technology” by Donatas Satas (van Nostrand, 1989).

The general expression “adhesive tape” comprises for the purposes of this invention all flat structures such as two-dimensional foils or foil sections, tapes with extended length and restricted width, tape sections, and the like, and finally also diecut products and labels.

The adhesive tape can be produced not only in the form of a roll, i.e. in the form of an Archimedean spiral wound up onto itself, but also in a form covered, on the adhesive side, with release materials, for example siliconized paper or siliconized foil.

A suitable release material is preferably a non-linting material, for example a plastics foil or a well-sized, long-fiber paper.

The running lengths of the adhesive tapes are in particular from 1000 to 30 000 m. Widths usually selected for the rolls are 10, 15, 19, 25, and 30 mm.

A foil-type backing composed entirely of, or of at least 50% by weight of, fluorinated polymer does not exhibit the disadvantages described above of fraying caused by glass fibers or fabric. This type of adhesive tape also has much lower stiffness, and it therefore conforms well to the mold. The backing material exhibits a certain extensibility which also helps the material to conform to the mold.

The interior strength of this type of backing material is moreover markedly higher, and no cleavage of parts of the backing can therefore be observed even on exposure to relatively large forces.

The invention is explained in more detail below with reference to an example, but without any intention thereby to restrict the invention in any way.

### EXAMPLE

50 g/m² of silicone adhesive (Dow Corning® Q2-7406)
100 μm PTFE backing (NORTON® 124 sintered extruded PTFE film)
Activation of the backing (by conventional etching process)

### COMPARATIVE EXAMPLE

50 g/m² of silicone adhesive (Dow Corning® Q2-7406)
150 μm PTFE-coated glass textile (backing)
Activation of the backing (by conventional etching process)

The adhesive tape of the invention in example 1 can be peeled from the substrate to leave almost no residue even after a plurality of demolding steps, and exhibited good release effect over the entire period.

In the case of the comparative example, residues of adhesive on the mold are observed on peeling of the adhesive tape even after the first cycle. After from three to five cycles the backing is observed to cleave in the z-direction, i.e. the backing cleaves within itself, and in some places a layer of PTFE remains on the surface; this is difficult to remove.

The adhesive side of the adhesive tapes here is applied to a mold equipped with a conventional release agent, for example Frekote NC 44 (a release agent comprising a mixture of dibutyl ether and polydimethylsiloxane (PDMS), this being a mixture of fully methylated linear siloxane polymers having terminal trimethylsiloxate units), or ME 143 from Miller Stephenson (a solvent-based suspension of low-molecular-weight PTFE). A plurality of construction cycles are carried out in accordance with FIG. 1. The temperature during hardening is from 80 to 90° C. The vacuum is 0.1 bar.

Up to ten construction cycles are simulated.

### BRIEF DESCRIPTION OF THE DRAWINGS

The process of the invention will be explained in more detail by way of example below with reference to a number of figures, without any restriction of the invention to these embodiments.

FIG. 1 is a side view of a section of the arrangement of the individual layers in the mold,

FIG. 2 is a plan view of the arrangement of the individual layers in the mold, and

FIG. 3 shows simplified detail from FIG. 1.

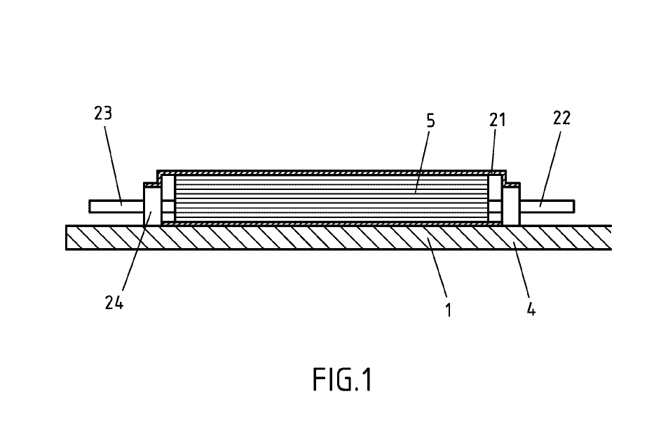

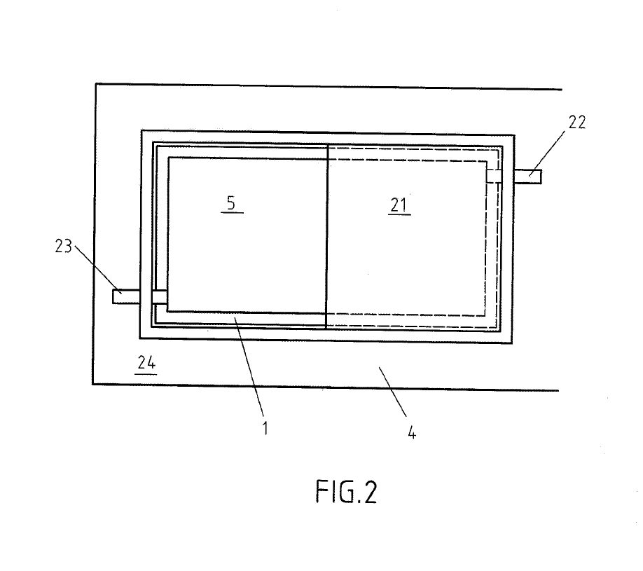

FIG. 1 is a side view of a section of the arrangement of the individual layers in the mold, and FIG. 2 is a plan view of same.

The mold 4 is equipped with a very thin layer, of thickness a few μm, of a release agent 6, for example a solvent-based suspension of low-molecular-weight PTFE, the thickness of which is not shown in the correct ratio in FIG. 1. It is applied with a cloth. The suspension then dries, giving a very thin film. A layer of the adhesive tape 1 is then applied to the internal side of the mold 4.

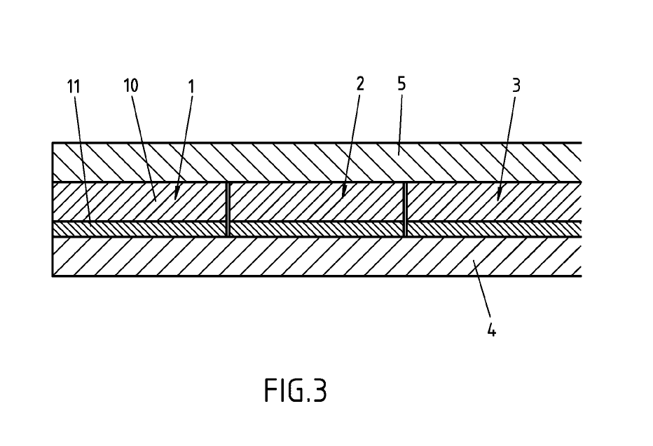

FIG. 3 shows that the edges of the individual strips of the adhesive tape 1, 2, 3 are abutted, i.e. leave no intervening spaces. The individual sections of adhesive tape 1, 2, 3 are composed of a backing foil 10 onto which an adhesive layer 11, in particular self-adhesive, has been applied.

Once the adhesive side of the adhesive tape 1 has been applied, the layers of material 5 that form the body are distributed on the adhesive tape.

A sealing foil 21 is then fixed above the material 5 with the aid of a second adhesive tape 24, thus providing an enclosed space.

FIG. 2 shows only half of the protective foil 21. The protective foil 21 is fixed on the mold 4 by the second adhesive tape 24.

The air is removed through an outlet 22. The resin is introduced by way of an inlet 23 to the layers of material 5 until these have been saturated.

The hardening process takes place.

Once this has been concluded, the sealing foil 21 is removed and the finished molding can be removed from the mold 4.

1. A process for the molding of a body in a mold, comprising the following steps:
application of an adhesive tape on the internal side of a mold
distribution, on the adhesive tape, of the layers of material that form the body
hardening of the layers of material
removal of the body from the mold,
where the adhesive tape comprises a backing foil onto one side of which a self-adhesive has been spread, and the backing foil comprises one or at least two fluoropolymers.

2. The process as claimed in claim 1,
wherein
the backing foil comprises 50% by weight of one or at least two fluoropolymers, based in each case on the entire composition of the backing foil, or the polymers forming the backing foil are composed of 100% by weight of one or at least two fluoropolymers.

3. The process as claimed in claim 1,
wherein
fluoropolymers used are PTFE (polytetrafluoroethylene), ETFE (poly(ethylene-co-tetrafluoroethylene)), FEP (poly(tetrafluoroethylene-co-hexafluoropropylene)), PVF (polyvinyl fluoride), PCTFE (polychlorotrifluoroethylene), ECTFE (poly(ethylene-co-chlorotrifluoroethylene), PVDF (poly(1,1-difluoroethene)), or PFA (perfluoroalkoxy polymers), or a mixture of two or more of the fluoropolymers mentioned.

4. The process as claimed in claim 1, wherein
the fluoropolymers have been mixed with other polymers selected from the group consisting of polyethylene terephthalate (PET), polyamides, polyurethanes, polyoxymethylene, polyvinyl chloride (PVC), polyethylene naphthalate (PEN), ethylene-vinyl alcohol (EVOH), polyvinylidene chloride (PVDC), polyvinylidene fluoride (PVDF), polyacrylonitrile (PAN), polycarbonate (PC), polyamide (PA), polyether sulfone (PES), polyimide (PI), polyarylene sulfides, and polyarylene oxides.

5. The process as claimed in claim 1, wherein the thickness of the backing foil is from 15 to 350 μm.

6. The process as claimed in claim 1, wherein the adhesive applied on the backing foil is a pressure-sensitive adhesive.

7. The process as claimed in claim 1, wherein the backing foil is composed of an at least two-layer laminate made of two or more foil layers.

8. The process as claimed in claim 1, wherein the backing foil is composed of at least two foil layers, where the two exterior foil layers are of different color.

9. The process as claimed in claim 1, wherein the quantity of the adhesive applied to the backing foil is from 10 to 200 g/m².

10. The process as claimed in claim 1, wherein the internal side of the mold is equipped with a release agent prior to application of the adhesive tape.

11. The process as claimed in claim 1, wherein the hardening of the layers of material takes place in vacuo.
